(19) United States
(12) Patent Application Publication
(10) Pub. No.: US 2010/0279617 A1
(43) Pub. Date: Nov. 4, 2010

(54) Methods and Apparatus for Reducing Receive Band Noise in Communications Transceivers

(75) Inventor: Saleh Osman, Cupertino, CA (US)

Correspondence Address: SNELL & WILMER L.L.P. (Panasonic), 600 ANTON BOULEVARD, SUITE 1400, COSTA MESA, CA, 92626, US

(73) Assignee: Matsushita Electric Industrial Co., Ltd.

(21) Appl. No.: 12/433,450

(22) Filed: Apr. 30, 2009

(51) Int. Cl. H04B 1/00; H04B 7/00

(52) U.S. Cl. 455/63.1; 370/277

(57) ABSTRACT

A transceiver adapted to reduce receive band noise includes a transmitter, a receiver, a duplexer coupled between the transmitter and receiver, and a baseband circuit configured in a feed-forward path between a baseband section of the transmitter and a baseband section of the receiver. The baseband circuit is configured to generate an error signal representing errors generated in the baseband section of the transmitter and feed forward the error signal to an insertion point in the baseband section of the receiver. The insertion point is configured to combine the error signal generated by the baseband circuit with a received signal containing receive band noise leaked from the transmitter to the receiver via a transmit signal leakage path in the duplexer. The error signal and received signal are combined to reduce the receive band noise in the received signal.

### FIELD OF THE INVENTION

The present invention relates communications systems and methods. More specifically, the present invention relates to methods and apparatus for reducing receive band noise in communications transmitters.

### BACKGROUND OF THE INVENTION

Personal wireless communications use has exploded ever since the cellular telephone was first introduced to the public in the early 1980s. Convergence of conventional cellular voice technology with Internet-based technology has only fueled the explosion. Data-intensive applications such as web browsing, streaming video, and e-mail, originally reserved for desktop computers, have now become available to mobile handset users. While these advances in technology no doubt benefit society, accommodating the ever-increasing number of users and satisfying demand for these high data rate applications has presented, and continues to present, tremendous challenges. One of the most difficult challenges relates to how best to use the radio frequency (RF) spectrum. The radio frequency (RF) spectrum is a limited and highly-regulated resource. For this reason, it must be used as efficiently as possible.

Spectral efficiency is increased in current and developing mobile telecommunications technologies, such as the Wideband Code Division Multiple Access (W-CDMA) air interface used in third generation (3G) telecommunications networks and the Long Term Evolution (LTE) air interface for soon-to-be deployed 4G networks, by employing non-constant envelope modulation schemes. Compared to 2G GSM (Global System for Mobile Communications), which uses a constant envelop modulation scheme, W-CDMA and LTE employ non-constant envelope modulation schemes, in which both the amplitude and angle (i.e., phase or frequency) of signals are modulated to convey information. The second degree of modulation freedom allows more data to be transmitted in a given amount of RF spectrum.

To avoid distorting non-constant envelope signals (i.e., to maintain linearity), conventional quadrature-modulator-based communications transmitters must employ a linear power amplifier (PA) (e.g., a Class A, B or AB amplifier). However, because linear PAs are not very energy efficient, the requirement of a linear PA results in a reduction in the energy efficiency of the transmitter. This efficiency versus linearity trade-off is highly undesirable, especially in battery-powered transmitters, such as are used in mobile handsets, since the poor energy efficiency shortens battery life.

Fortunately, the efficiency versus linearity trade-off of conventional quadrature-modulator-based transmitters can be avoided by using an alternative type of transmitter known as a polar transmitter. In a polar transmitter, the signal to be transmitted is processed in terms of its amplitude and phase (i.e., in polar coordinates) rather than in rectangular coordinates. This allows the envelope information in the polar-coordinate signal to be temporarily removed so that the RF input to the polar transmitter's PA has a constant envelope containing only phase modulation. With no amplitude variation in the constant envelope signal, a much more efficient nonlinear PA can be used.

FIG. 1 is a drawing showing the basic elements of a polar transmitter 100. The polar transmitter 100 comprises a baseband processor 102; a CORDIC (Coordinate Rotation Digital Computer) converter 104; an amplitude modulation (AM) path including an amplitude modulator 106; a phase modulation (PM) path including a phase modulator 108; a PA; and an antenna 112.

During operation the baseband processor 102 generates rectangular-coordinate in-phase (I) and quadrature phase (Q) signals from data bits in a digital message to be transmitted and according to an applicable non-constant envelope modulation scheme. The CORDIC converter 104 converts the rectangular-coordinate I and Q signals to polar coordinates, to produce amplitude and phase component signals ρ and θ. In the AM path, the amplitude modulator 106 modulates a direct current power supply voltage Vsupply (e.g., as provided by a battery) according to the amplitude information in the amplitude component signal ρ. The resulting amplitude-modulated power supply signal Vs(t) is coupled to the power supply port of the PA 110.

In the PM path, the phase modulator 108 modulates an RF carrier signal according to the phase information in the phase component signal θ. The resulting phase-modulated RF carrier signal is coupled to the RF input port RFIN of the PA 110. Because the phase-modulated RF carrier signal has a constant envelope, the PA 110 can be operated in its nonlinear region of operation without the risk of signal peak clipping.

Typically, the PA 110 is implemented as a switch-mode type of PA (e.g., a Class D, E or F switch-mode PA) operating between compressed and cut-off states. When configured in this manner, the envelope information in the amplitude-modulated power supply signal Vs(t) is restored at the RF output RFOUT of the PA 110, as the PA 110 amplifies the phase-modulated RF carrier signal. Amplitude-dependent amplitude and phase errors introduced by the PA 110 are accounted for by characterizing the AM-AM and AM-PM responses of the PA 110 prior to operation (i.e., during design and manufacture) and then pre-distorting the amplitude and phase component signals ρ and θ during normal operation based on the characterized results. Finally, the desired non-constant envelope amplitude- and phase-modulated RF carrier signal appearing at the RF output RFOUT of the PA 110 is coupled to the antenna 112, which radiates the signal over the air to a remote receiver (e.g., a base station).

In many applications the polar transmitter 100 is co-located with an associated receiver and combined with the receiver to share common resources. For example, in a mobile handset the transmitter and receiver are configured to share a common antenna 204, and baseband processing functions are provided for by a common baseband processor. When combined in this manner, the transmitter and receiver are collectively referred to as a “transceiver.”

Transceivers are generally categorized as being either “half-duplex” or “full-duplex”. In a half-duplex transceiver, only one of the transmitter and receiver is permitted to operate at any give time. In a full-duplex transceiver the transmitter transmits and the receiver receives at the same time. Whether half-duplex or full-duplex operation is used is usually determined by the wireless technology involved. For example, 2G cellular technologies such as GSM and Enhanced Data rates for GSM Evolution (EDGE) employ half-duplex operation, while 3G Universal Mobile Telecommunication System (UMTS) cellular technology based on the W-CDMA air interface employs full-duplex operation.

FIG. 2 is a drawing of a full-duplex transceiver 200 made up of a polar transmitter portion 202 and a receiver portion 204. The polar transmitter portion 202 is configured in a transmit (Tx) path and includes a CORDIC converter 104, amplitude and phase modulators 106 and 108, and a PA 110, similar to the polar transmitter 100 described in FIG. 1 above. The receiver portion 204 includes a low noise amplifier (LNA) 206, a quadrature demodulator 208, a variable-gain amplifier (VGA) 210 and an analog-to-digital converter (ADC) 212. The transmitter and receiver portions 202 and 204 are configured to share the same antenna 214, via a duplexer 216, and the processing resources provided by a common baseband processor 201.

In the Tx path, the phase modulator 106 is configured to modulate an RF carrier signal provided by a transmit path local oscillator (Tx-LO) according to the phase information in the phase component signal θ. The phase-modulated RF carrier signal produced at the output of the phase modulator 106 is recombined with the amplitude modulated signal Vs(t) by the PA 110, in the manner described above, resulting in an amplitude- and phase-modulated transmit signal Tx signal having a center frequency f_{Tx} centered in a Tx band. The Tx signal is passed through the duplexer 216 and then fed to the antenna 214, which radiates the Tx signal over the air to a remote receiver.

In the Rx path, the LNA 206 amplifies a receive (Rx) signal centered at a center frequency f_{Rx} in a Rx band. The quadrature demodulator 208 operates to downconvert the Rx signal from RF to baseband. After the downconverted signal has been amplified by the VGA 210, the ADC 212 converts the downconverted and amplified signal to a digital baseband signal. Finally, the digital baseband signal is coupled to the baseband processor 201, which operates to recover the received digital message.

So that the full-duplex transceiver 200 may simultaneously transmit the Tx signal and receive the Rx signal, the transmitter and receiver portions 202 and 204 are designed to transmit and receive in different, and ideally non-overlapping Tx and Rx frequency bands. The Tx and Rx bands are usually set by a standards body. For example, the Tx and Rx bands for UMTS/W-CDMA systems are set by the 3rd Generation Partnership Project (3GPP), which is a standards body composed of telecommunications associations from North America, Europe, South Korea, China and Japan. FIG. 3 shows the frequency ranges of the first six (I-VI) operating bands of the 3GPP standard for UMTS frequency division duplex (FDD) operation. Each operating band comprises a pair of geographic-specific Tx (uplink) and Rx (downlink) bands. FIG. 4 shows the Tx-Rx frequency separation for the first six operating bands.

Ideally, the Tx and Rx frequencies of any paired operating band do not overlap, as illustrated in FIG. 5A. However, due to practical constraints the Tx and Rx bands do, in fact, overlap to some extent, as illustrated in FIG. 5B. The extent to which the Tx and Rx frequencies overlap depends on a number of factors, including how close the Tx and Rx frequency bands are to one another, the relative and absolute powers of the Tx and Rx signals, external factors affecting the noise performance of the transceiver, and technology, size and cost restrictions involved in the design of the transmitter and receiver hardware.

In FDD applications, the most important component in maintaining adequate Tx-Rx band separation is the duplexer 216. The principle function of the receiver portion 204 is to isolate the transmitter portion 202 from the sensitive front end of the receiver portion 204. The duplexer 216 comprises a three-port device that includes a Rx path band-pass filter (BPF) 218 coupled between the Rx path and the antenna port, a Tx path BPF 220 coupled between the Tx path and the antenna port, and an impedance transforming circuit (not shown in the drawing). The impedance transforming circuit allows both filters to connect to the common antenna 214. The purpose of the Rx and Tx path BPFs 218 and 220 are to prevent the Tx signal from desensitizing the front end of the receiver portion 204 and attenuate out-of-band Tx signal energy at the Rx signal frequency from leaking into the front-end of the receiver portion 204.

For an ideal duplexer, the noise floor (NF_{Rx}) of the receiver portion 204 is determined only by thermal noise and noise generated by the receiver portion 204 itself. However, because no practical duplexer is ideal, some level of transmitter-generated noise having frequencies falling with the Rx band (i.e., Rx band noise) inevitably leaks through the duplexer 216 into the front end of the receiver portion 204. This transmitter-generated Rx band noise has the undesirable effect of increasing the noise floor (NF′_{Rx}) of the receiver portion 204.

Additional filtering in the polar and/or I-Q domains can be employed to supplement the filtering provided by the duplexer 216. However, the additional filtering is only moderately effective, and has the side effects of degrading the close-in Tx spectrum and degrading modulation accuracy. These undesirable side effects are more pronounced when the transmitter portion 202 is implemented using a polar modulator, as in FIG. 2 above. In a polar transmitter, the polar-coordinate amplitude and phase component signals ρ and θ have significantly higher bandwidths than the rectangular-coordinate I and Q signals. The reason for this is that for some modulation schemes, particularly those that produce signals having a high peak-to-average ratios (PAR), the signal trajectory of the complex baseband signal passes through (or very close to) the origin in the I-Q signal plane, as illustrated in FIG. 6. As the complex signal passes through (or very close to) the origin, the amplitude of the amplitude component signal ρ and the phase of the phase component signal θ begin to change very quickly. In fact, when the signal trajectory does pass through the origin, the phase component signal θ undergoes a near instantaneous phase reversal of ±180°.

To prevent receiver desensitization, it is desirable to filter the amplitude and phase component signals ρ and θ for frequencies that fall within the Rx band, beyond the filtering capabilities provided by the duplexer 216. However, the level of additional filtering that can be applied is limited. If the filtering is too aggressive, the signal trajectory of the complex signal becomes distorted, making it difficult or impossible to comply with transmit signal metrics such as error vector magnitude (EVM) and adjacent channel leakage ratio (ACLR).

Considering the foregoing limitations of reducing Rx band noise in conventional full-duplex transceivers, it would be desirable to have methods and apparatus for reducing Rx band noise in full-duplex transceivers that are effective at reducing Rx band noise but which do not adversely affect the ability to comply with transmit signal metrics such as EVM and ACLR.

### SUMMARY OF THE INVENTION

Methods and apparatus for reducing receive band noise in communications transceivers are disclosed. An exemplary transceiver adapted to reduce receive band noise includes a transmitter, a receiver, a duplexer coupled between the transmitter and receiver, and a baseband circuit configured in a feed-forward path between a baseband section of the transmitter and a baseband section of the receiver. The baseband circuit is configured to generate an error signal representing errors generated in the baseband section of the transmitter and feed forward the error signal to an insertion point in the baseband section of the receiver. The insertion point is configured to combine the error signal generated by the baseband circuit with a received signal containing receive band noise leaked from the transmitter to the receiver via a transmit signal leakage path in the duplexer. The error signal and received signal are combined in a manner that reduces the receive band noise in the received signal.

Further features and advantages of the present invention, including a description of the structure and operation of the above-summarized and other exemplary embodiments of the invention, will now be described in detail with respect to accompanying drawings, in which like reference numbers are used to indicate identical or functionally similar elements.

### BRIEF DESCRIPTION OF THE DRAWINGS

FIG. 1 is drawing showing the basic elements of a polar transmitter;

FIG. 2 is a drawing of a full-duplex transceiver including a polar transmitter portion and a receiver portion;

FIG. 3 is a table showing the transmit (Tx) and receive (Rx) frequency ranges of the first six (I-VI) operating bands of the 3rd Generation Partnership Project (3GPP) standard for 3G Universal Mobile Telecommunication System (UMTS) frequency division duplex (FDD) cellular technology;

FIG. 4 is a table showing the Tx-Rx frequency separation for the first six (I-VI) operating bands of the 3GPP standard for 3G UMTS FDD cellular technology;

FIG. 5A is a power spectral density (PSD) diagram of idealized Tx and Rx frequency bands;

FIG. 5B is a PSD diagram of actual Tx and Rx frequency bands;

FIG. 6 is diagram of a complex signal in the complex signal plane, illustrating how a signal trajectory of the complex signal can pass through the origin;

FIG. 7 is a drawing of a full-duplex transceiver, according to an embodiment of the present invention;

FIG. 8A is a drawing of an amplitude correction circuit that is configured between the baseband sections of the polar transmitter and receiver portions of the full-duplex transceiver in FIG. 7, in accordance with an embodiment of the present invention; and

FIG. 8B is a drawing of a phase correction circuit that is configured between the baseband sections of the polar transmitter and receiver portions of the full-duplex transceiver in FIG. 7, in accordance with an embodiment of the present invention.

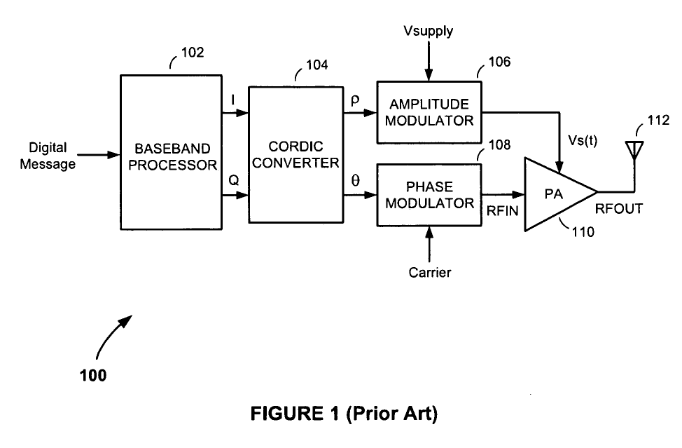

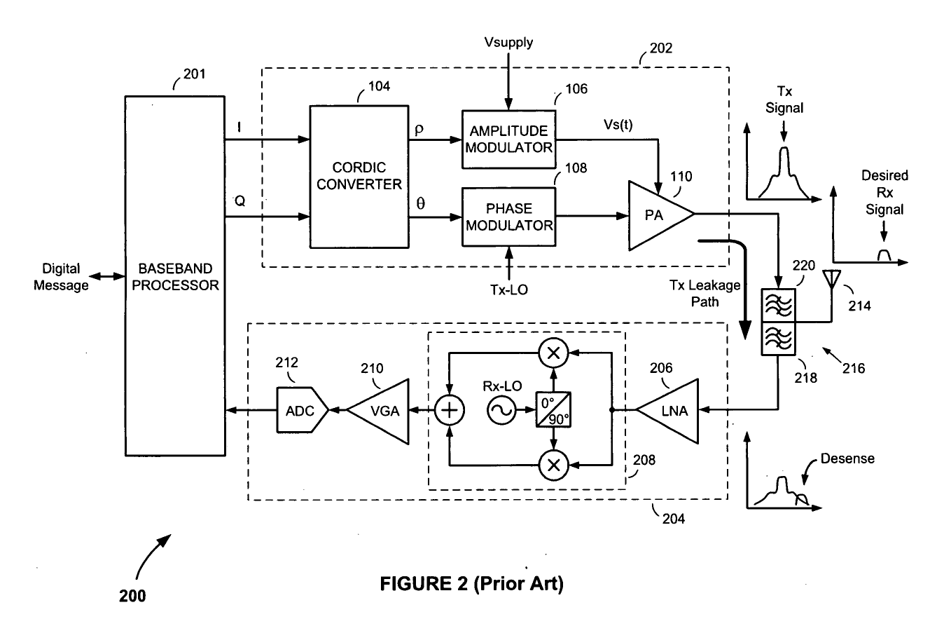

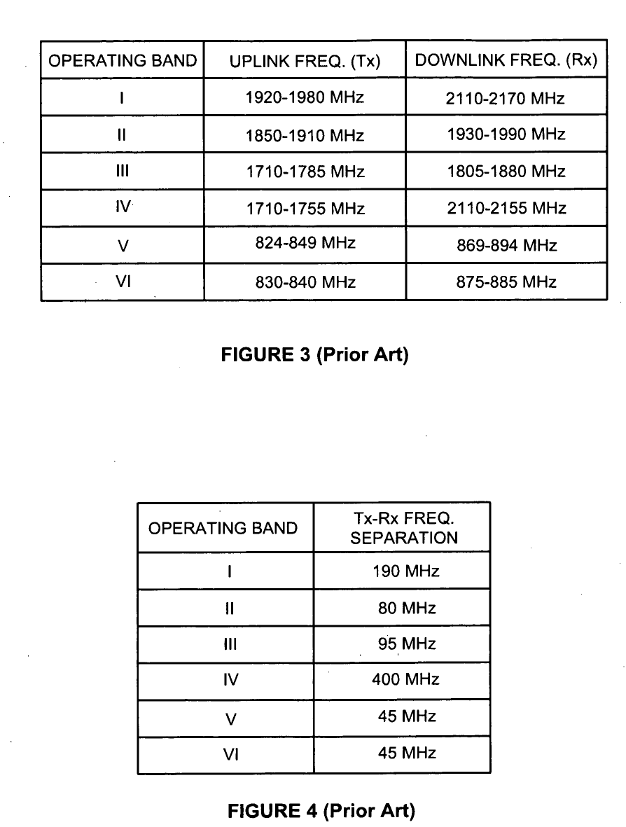

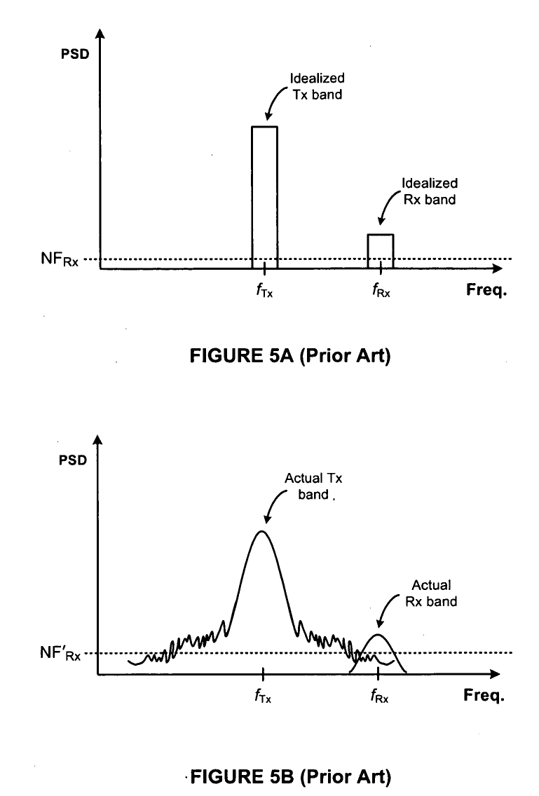

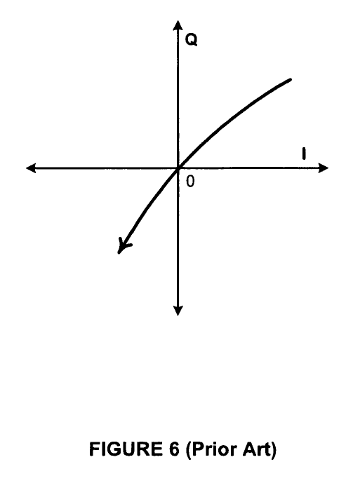

### DETAILED DESCRIPTION

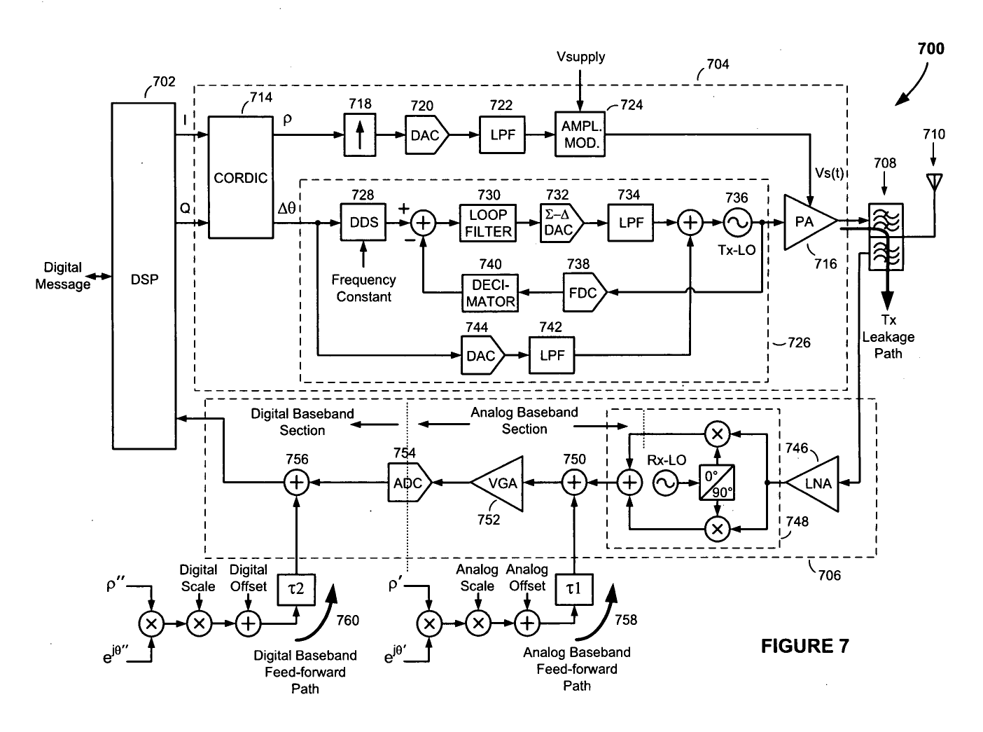

Referring to FIG. 7, there is shown a full-duplex transceiver 700, according to an embodiment of the present invention. The full-duplex transceiver 700 comprises a digital signal processor (DSP) 702; a polar transmitter portion 704 configured in a transmit (Tx) path; a receiver portion 706 configured in a receive (Rx) path; a duplexer 708 and an antenna 710. According to one embodiment, the transceiver 700 comprises a multi-band and/or multi-mode transceiver capable of transmitting and receiving in various Tx and Rx frequency bands and/or according to multiple modulation schemes.

The DSP 702 of the full-duplex transceiver 700 is responsible for performing the digital baseband processing functions of the transmitter and receiver portions 704 and 706. The DSP 702 is implemented in hardware or a combination of hardware and software, and comprises a microprocessor, microcontroller, other programmable integrated circuit (such as a field-programmable gate array) or an application specific integrated circuit (ASIC). The transmitter processing functions of the DSP 702 include generating in-phase (I) and quadrature phase (Q) sequences of symbols from data bits in a digital message to be transmitted according to an applicable modulation scheme, and sampling and pulse-shaping the I and Q sequences of symbols to produce band-limited digital I and Q digital data streams for the polar transmitter portion 704. The receiver processing functions include extracting the received digital message from a baseband signal that has been downconverted by the receiver portion 706. In one embodiment, the DSP 702 is further configured to monitor bit error rate (BER), received signal strength indicator (RSSI), direct current (DC) offset, signal-to-noise ratio (SNR), or some combination thereof, to assist in adaptive Rx band noise reduction.

The polar transmitter portion 704 of the full-duplex transceiver 700 comprises a CORDIC (Coordinate Rotation Digital Computer) converter 714, an amplitude modulation (AM) path, a phase modulation (PM) path and a power amplifier (PA) 716. (Note that although the PA 716 is shown as including only a single amplifier stage, two or more amplifying stages may be used to increase the dynamic range of the PA 716.) It should be noted that although a polar transmitter is employed in this exemplary embodiment, a quadrature-modulator-based transmitter may be alternatively used. Further, whereas the polar transmitter portion 704 is shown as comprising a direct conversion type of polar transmitter (i.e., one that directly converts the baseband signals up to RF), an intermediate frequency (IF) stage me be included between the baseband and RF portions of the polar transmitter portion 704.

The CORDIC converter 714 operates to convert the samples in the digital I and Q digital data streams into polar-coordinate digital amplitude and phase-difference component signals ρ and Δθ. Note that the phase-difference component signal Δθ is the sample time by sample time change in the desired phase of the modulated signal. It is phase accurate in the sense that if it is accumulated at the sample clock rate, an exact phase angle will result. It should also be mentioned that although shown as being separate from the DSP 702, the CORDIC converter 714 may be included as part of the DSP 702.

The AM path of the polar transmitter portion 704 includes a data rate converter 718 (e.g., an interpolator), an AM path digital-to-analog converter (DAC) 720, an AM path low-pass filter (LPF) 722 and an amplitude modulator 724 comprising a switch-mode converter (e.g., a Class S modulator), linear regulator or combination of the two. The data rate converter 718 is optional and may be, like the CORDIC converter 714, included as a component of the DSP 702. The data rate converter 718 operates to increase the sample rate of the amplitude component signal ρ. This oversampling technique causes images created by the AM path DAC 720 to be shifted to a higher frequency, thereby relaxing the roll-off requirements of the subsequent AM path LPF 722. The AM path DAC 720 operates to convert the oversampled amplitude component signal ρ to an analog AM signal. The AM path LPF 722 performs a reconstruction process that smoothes out steps in the analog signal resulting from the DAC conversion process. Finally, the analog AM signal is coupled to the input of the amplitude modulator 724, which operates to amplitude modulate a DC power supply voltage Vsupply according to the AM in the analog AM signal. The resulting amplitude-modulated power supply signal Vs(t) is coupled to the power supply port of the PA 716.

The PM path of the polar transmitter portion 704 includes a phase modulator 726 comprising a frequency-locked loop (FLL) and a high-speed feed-forward path examples of which are provided in U.S. Pat. No. 6,094,101 and W. B. Sander, S. V. Schell and B. L. Sander, “Polar Modulator for Multi-Mode Cell Phones,” IEEE 2003 Custom Integrated Circuits Conference, 21-24 September 2003, pp. 439-445, both of which are hereby incorporated by reference.

The FLL comprises a direct digital synthesizer (DDS) 728, loop filter 730, Σ-Δ DAC 732, first LPF 734 configured in a main signal path, a voltage controlled oscillator (VCO) 736, and a frequency-to-digital converter (FDC) 738 and decimator 740 configured in a feedback path. The primary purposes of the FLL are to keep the carrier frequency accurate and to maintain precise tracking of the input phase. Based on the frequency represented in the phase-difference component signal Δθ relative to a digital frequency constant representing a center frequency of the applicable Tx band, the DDS 728 generates a first digital stream representing the desired output frequency of the phase modulator 726. The FDC 738 digitizes the output of the VCO 736 to provide a digital representation of the actual output frequency of the phase modulator 726. After being decimated down to the resolution of the first digital stream, the first and second digital streams are summed with opposite polarities to produce an error signal representing the frequency error between the desired output frequency and the actual output frequency. The loop filter 730, which may be implemented as a finite impulse response (FIR) filter, filters the error signal, and the Σ-Δ DAC 732 converts the filtered error signal to an analog signal having an amplitude that is proportional to the frequency error. The first LPF 734 operates to attenuate quantization errors in the analog signal generated during the digital-to-analog conversion process.

The high-speed feed-forward path containing a second LPF 742 and a feed-forward DAC 744 is used to circumvent loop bandwidth limitations of the FLL, thereby allowing a modulation bandwidth greater than the FLL loop bandwidth to be realized. The outputs of the first and second LPFs 742 and 742 in the main and high-speed feed-forward paths are summed to generate a tuning voltage for the VCO 736. The VCO 736 responds to the tuning voltage by increasing or decreasing its output frequency in a manner that forces the actual output frequency of the FLL to track the desired frequency represented in the first digital stream. When the VCO 736 locks to the desired frequency the density of ones and zeroes in the first and second digital streams are, on average, equal and the error produced by their difference is zero. When frequency locked, the phase modulator 726 provides a phase accurate representation of the phase modulation represented in the original phase-difference component signal Δθ.

It should be pointed out that the phase modulator 726 of the polar transmitter portion 704 shown and described here is but one of several ways in which the phase modulator may be implemented. Other types of phase, frequency or phase/frequency modulators, either single- or multi-point, may be alternatively used, as will be appreciated by those of ordinary skill in the art.

The phase-modulated RF carrier signal produced at the output of the phase modulator 726 is coupled to the RF input of the PA 716 while the amplitude-modulated power supply signal Vs(t) is coupled to the power supply port of the PA 716. In one embodiment the PA 716 is implemented as a switch-mode type of PA (e.g., a Class D, E or F switch-mode PA) operating between compressed and cut-off states. When configured in this manner, the envelope information in the amplitude-modulated power supply signal Vs(t) is restored at the RF output of the PA 716, as the PA 716 amplifies the phase-modulated RF carrier signal. The desired non-constant envelope amplitude- and phase-modulated RF carrier signal appearing at the RF output of the PA 716 is coupled to the antenna 710, via the duplexer 708, and finally radiated over the air to a remote receiver (not shown in the drawing).

The receiver portion 706 of the full-duplex transceiver 700 comprises a front end including a low-noise amplifier (LNA) 746, a quadrature demodulator 748, a first insertion point 750, a variable-gain amplifier (VGA) 752, an analog-to-digital converter (ADC) 754 and a second insertion point 756. During operation, the LNA 746 amplifies an amplitude and phase-modulated RF signal received from a remote transmitter (e.g., a base station transmitter). The amplified RF signal is then downconverted to analog baseband by the quadrature demodulator 748, amplified by the VGA 752, and finally converted to digital baseband by the ADC 754. The receiver portion 706 in this exemplary embodiment comprises a direct conversion receiver, i.e., a receiver that downconverts the received RF signal directly down to baseband. However, it could be modified to further include an IF downconversion stage.

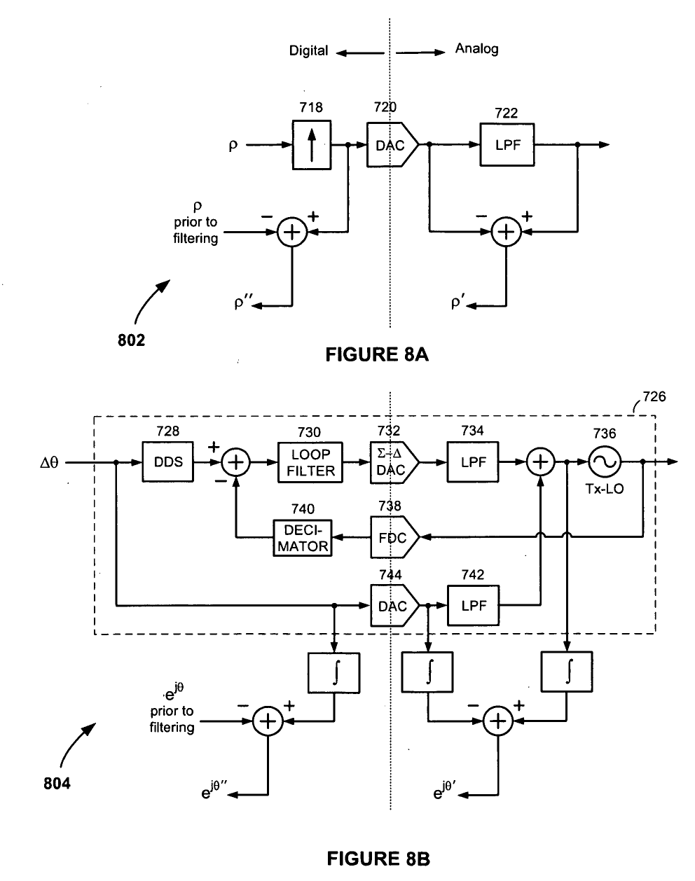

The first and second insertion points 750 and 756 of the receiver portion 706 are configured to receive an analog baseband correction signal ρ′e^{jθ′} from an analog baseband feed-forward path 758 and/or a digital baseband correction signal ρ″e^{jθ″} from a digital baseband feed-forward path 760. The analog and digital baseband correction signals ρ′e^{jθ′} and ρ″e^{jθ″} are generated by amplitude and phase correction circuits 802 and 804 shown in FIGS. 8A and 8B, respectively, the digital portions of which may be incorporated in the DSP 702. It should be pointed out that while in the exemplary embodiment described here the baseband correction signals are generated and inserted in the receiver portion 706 in terms of polar coordinates, in an alternative embodiment the baseband correction signals are generated in terms of rectangular coordinates, or converted to rectangular coordinates after being first generated in polar coordinates, and then combined with the downconverted I and Q baseband signals in the rectangular domain, rather than in the polar domain.

The amplitude and phase correction circuits 802 and 804 comprise a baseband circuit that is operable to pre-calculate Rx band noise that is introduced into the front end of the receiver portion 706 via the Tx leakage path of the duplexer 708. The analog and digital baseband correction signals ρ′e^{jθ′} and ρ″e^{jθ} provide estimates of errors in the Tx signal, e.g., errors characterizing Rx band noise that are introduced into the front end of the receiver portion 706 via the Tx leakage path of the duplexer 708. The amplitude correction circuit 802 (FIG. 8A) is coupled between the AM path of the polar transmitter portion 704 and either or both the analog and digital baseband feed-forward paths 758 and 760, depending on whether analog, digital or a combination of analog and digital signal correction is to be performed. The analog amplitude correction component ρ′ of the analog baseband correction signal ρ′e^{jθ′} is formed from the difference between the analog AM signal prior to filtering by the AM path LPF 722 and the AM signal after it has been filtered by the AM path LPF 722. Accordingly, the resulting analog amplitude correction component ρ includes amplitude errors attributable to the filtering performed by the AM path LPF 722.

The digital amplitude correction component ρ″ of the digital baseband correction signal ρ″e^{jθ″} is formed from the difference between the digital amplitude component signal ρ prior to filtering and the signal as it appears just prior to being converted to an analog waveform by the AM path DAC 720. Accordingly, the resulting digital amplitude correction component ρ″ includes amplitude errors attributable to the digital processing of the digital amplitude component signal ρ in the AM path.

The phase correction circuit 804 (FIG. 8B) is coupled between the PM path of the polar transmitter portion 704 and either or both the analog and digital baseband feed-forward paths 758 and 760, again depending on whether analog, digital or a combination of analog and digital signal correction is to be performed. The analog phase correction component e^{jθ′} the analog baseband correction signal ρ′e^{jθ′} is formed from the difference between an analog PM signal that is produced by integrating the frequency modulation output of the feed-forward DAC 744 prior to being filtering by the second LPF 742 in the high-speed feed-forward path of the phase modulator 726 and a filtered analog PM signal that is produced by integrating the sum of the analog signals appearing at the outputs of the first and second LPFs 734 and 742 in the main and high-speed feed-forward paths of the FLL of the phase modulator 726. Accordingly, the resulting analog phase correction component e^{jθ′} includes phase errors attributable to the filtering performed by the first and second LPFs 734 and 742.

The digital phase correction component e^{jθ′} of the digital baseband correction signal ρ″e^{jθ″} is formed from the difference between a digital phase component signal e^{jθ} prior to filtering and a digital phase component signal produced by integrating the digital phase-difference signal Δθ as it appears just prior to being coupled to the input of the phase modulator 726. Accordingly, the resulting digital phase correction component e^{jθ′} includes phase errors attributable to the digital processing of the digital phase-difference signal Δθ in the PM path prior to being modulated by the phase modulator 726.

Depending on whether analog, digital or a combination of analog and digital signal correction is to be performed, the analog and/or digital baseband correction signals ρ′e^{jθ′} and ρ″e^{jθ″} signals are fed forward to first and second insertion points 750 and 756, via the analog baseband feed-forward path 758 and the digital baseband feed-forward path 760. The first insertion point 750 in the analog baseband section combines the fed-forward analog baseband correction signal ρ′e^{jθ′}, with the downconverted Rx signal appearing at the output of the quadrature demodulator 748. By feeding forward the analog baseband correction signal ρ′e^{jθ′}, Rx band noise, including DAC images generated by the digital-to-analog conversion process and analog filtering errors generated by the LPFs in the AM and PM paths in the polar transmitter portion 704, can be reduced in the Rx path prior to transmission, thereby circumventing the limited isolation capability of duplexer 708.

To account for the propagation delay of the Tx leakage path (i.e., to account for the delay caused by the PA 716, duplexer 708, LNA 746 and quadrature demodulator 748), and ensure optimum Rx band noise reduction (e.g., to ensure that the analog baseband correction signal ρ′e^{jθ′} is out of phase with the actual Rx noise leaked into the receiver portion), a first delay element π1 is disposed in the analog baseband feed-forward path 758 between the combined output of the amplitude and phase correction circuits 802 and 804 and the first insertion point 750. The delay provided by the first delay element π1 may be calibrated during design and production or may be configured to be controlled during operation to adapt to variations in the propagation delay in the Tx leakage path, e.g., due to process voltage and temperature (PVT). Rx band noise reduction may be further optimized by adjusting the amplitude and/or offset of the analog baseband correction signal ρ′e^{jθ′}. Depending on the application, it may be sufficient to determine a set of static analog scale and offset factors during the calibration and production phase, which are then applied during operation. In other applications, the analog scale and offset factors are dynamic and adaptively varied during operation, e.g., by monitoring BER, RSSI, DC offset, SNR, or some combination thereof.

The second insertion point 756 in the digital baseband section of the receiver portion 706 combines the fed-forward digital baseband correction signal ρ″e^{jθ″} with the digital baseband signal appearing at the output of ADC 754. By feeding forward the digital baseband correction signal ρ″e^{jθ″}, digitally-induced Rx band noise, such as caused by digital filtering in the AM and PM paths of the polar transmitter portion 704, can be reduced in the Rx path prior to transmission, thereby circumventing the limited isolation capability of duplexer 708. Similar to the analog baseband feed-forward path 758, the digital baseband feed-forward path 760 includes a second delay element π2, which can be calibrated during design and production to a fixed value, or configured to be controlled during operation to adapt to PVT-related variations in the combined propagation delays of the Tx leakage path and Rx path leading up to the second insertion point 756. Static or dynamic scale and offset factors may also be included to optimize Rx band noise reduction, similar to as in the analog baseband feed-forward path 758. If dynamic scale and offset factors are used, the DSP 702 can be configured to monitor BER, RSSI, DC offset, SNR, or some combination thereof, and respond by adaptively adjusting the dynamic scale and offset factors in order to optimize Rx band noise reduction.

While the methods and apparatus of the invention are subject to various modifications and alternative forms, specific embodiments have been shown by way of example in the drawings and described in detail herein. However, it should be understood that the methods and apparatus of the invention are not limited to the particular forms disclosed. Rather, they encompass all modifications, equivalents, and alternatives that fall within the spirit and scope of the invention as defined in the appended claims.

What is claimed is:

1. A circuit, comprising:
a transmitter;
a receiver; and
a baseband circuit configured in a feed-forward path between a baseband section of said transmitter and a baseband section of said receiver, said baseband circuit configured to generate an error signal representing errors generated in the baseband section of said transmitter and feed forward the error signal to the baseband section of said receiver.

2. The circuit of claim 1, further comprising:
a duplexer coupled between said transmitter and said receiver, said duplexer having a transmit signal leakage path between an output of said transmitter and an input of said receiver; and
an insertion point in the baseband section of said receiver configured to receive and combine the fed forward error signal with a received signal containing receive band noise leaked from said transmitter to said receiver via the transmit signal leakage path in said duplexer.

3. The circuit of claim 2 wherein the feed-forward path includes a delay element configured so that the combination of the fed-forward error signal with the received signal results in optimized receive band noise reduction in said receiver.

4. The circuit of claim 1 wherein said baseband circuit comprises a digital baseband circuit configured to generate a digital error signal representing errors generated by digital circuitry in the baseband section of said transmitter.

5. The circuit of claim 1 wherein said baseband circuit comprises an analog baseband circuit configured to generate an analog error signal representing errors generated by analog circuitry in the baseband section of said transmitter.

6. The circuit of claim 1 wherein said baseband circuit comprises:
a digital baseband circuit configured to generate a digital error signal representing errors generated by digital circuitry in the baseband section of said transmitter; and
an analog baseband circuit configured to generate an analog error signal representing errors generated by analog circuitry in the baseband section of said transmitter.

7. The circuit of claim 1 wherein said transmitter comprises a polar transmitter and said baseband circuit is configured to generate amplitude and phase correction components of said error signal.

8. The circuit of claim 7, further comprising:
a duplexer coupled between said polar transmitter and said receiver, said duplexer having a transmit signal leakage path between an output of said polar transmitter and an input of said receiver; and
an insertion point in the baseband section of said receiver configured to receive and combine the fed-forward error signal with a received signal containing receive band noise leaked from said polar transmitter to said receiver via the transmit signal leakage path in said duplexer.

9. The circuit of claim 8 wherein the feed-forward path includes a delay element configured so that combination of the fed-forward error signal with the received signal results in optimized receive band noise reduction in said receiver.

10. A circuit, comprising:
a transmitter;
a receiver;
a duplexer configured between an output of said transmitter and said receiver;
means for estimating receive band noise introduced into said receiver through a leakage path in said duplexer; and
means for reducing receive band noise in said receiver based on an estimate of receive band noise provided by said means for estimating.

11. The circuit of claim 10 wherein said means for estimating receive band noise is configured in a feed-forward path between a baseband section of said transmitter and a baseband section of said receiver.

12. The circuit of claim 11 wherein said means for estimating receive band noise comprises means for estimating receive band noise attributable to baseband circuitry in said transmitter.

13. The circuit of claim 12 wherein said feed-forward path comprises an analog feed-forward path and said means for estimating receive band noise attributable to baseband circuitry comprises means for estimating receive band noise attributable to analog baseband circuitry in said transmitter.

14. The circuit of claim 12 wherein said feed-forward path comprises a digital feed-forward path and said means for estimating receive band noise attributable to baseband circuitry comprises means for estimating receive band noise attributable to digital baseband circuitry in said transmitter.

15. The circuit of claim 10 wherein said transmitter comprises a polar transmitter and said means for estimating receive band includes means for generating amplitude and phase correction components of an error signal.

16. The circuit of claim 15 wherein said receiver includes an insertion point configured to combine said error signal with a received signal containing receive band noise leaked from said polar transmitter to said receiver via said duplexer.

17. A method of reducing receive band noise in a transceiver, comprising:
estimating receive band noise in a transmit signal of a transmitter;
feeding forward the estimate of receive band noise in the transmit signal to a receiver along a feed-forward path between the transmitter and receiver;
receiving a receive signal in the receiver, said receive signal including receive band noise leaked through a leakage path in a duplexer coupled between the transmitter and receiver; and
reducing receive band noise in the receive signal based on the estimate of receive band noise fed forward to the receiver along the feed-forward path.

18. The method of reducing receive band noise of claim 17 wherein:
estimating receive band noise in the transmit signal comprises estimating receive band noise attributable to analog baseband circuitry of the transmitter;
feeding forward the estimate of the receive band noise comprises feeding forward the estimate of receive band noise along an analog feed-forward path between analog baseband sections of the transmitter and receiver; and
reducing receive band noise in the receive signal comprises reducing receive band noise based on the estimate of receive band noise attributable to analog baseband circuitry of the transmitter fed-forward to the receiver along the analog feed-forward path.

19. The method of reducing receive band noise of claim 17 wherein:
estimating receive band noise in the transmit signal comprises estimating receive band noise attributable to digital baseband circuitry of the transmitter;
feeding forward the estimate of the receive band noise comprises feeding forward the estimate of receive band noise along a digital feed-forward path between digital baseband sections of the transmitter and receiver; and
reducing receive band noise in the receive signal comprises reducing receive band noise based on the estimate of receive band noise attributable to digital baseband circuitry of the transmitter fed-forward to the receiver along the digital feed-forward path.

20. The method of reducing receive band noise of claim 17 wherein:
the transmitter comprises a polar transmitter; and
estimating receive band noise in the transmit signal of the transmitter is performed in the polar domain.

21. The method of reducing receive band noise of claim 20 wherein reducing receive band noise in the receive signal based on the estimate of receive band noise fed forward to the receiver along the feed-forward path is performed at baseband in the polar domain.

22. The method of reducing receive band noise of claim 20 wherein reducing receive band noise in the receive signal based on the estimate of receive band noise fed forward to the receiver along the feed-forward path is performed at baseband in the quadrature domain.
